(19) United States
(12) Patent Application Publication
(10) Pub. No.: US 2023/0035831 A1
(43) Pub. Date: Feb. 2, 2023

(54) HOLLOW FIBER MEMBRANE SYSTEMS AND METHODS

(71) Applicant: PENTAIR FILTRATION SOLUTIONS, LLC, Hanover Park, IL (US)

(72) Inventors: Mohan KHADILKAR, Plymouth, MN (US); Leo VREDENBREGT, Hanover Park, IL (US); Remon DEKKER, Hanover Park, IL (US); Mike BECK, Hanover Park, IL (US); Jens POTRECK, Ahaus-alstaette (DE)

(21) Appl. No.: 17/758,593

(22) PCT Filed: Jan. 11, 2021
(86) PCT No.: PCT/US2021/012933

§ 371 Date: Jul. 11, 2022

Related U.S. Application Data
(60) Provisional application No. 62/959,477, filed on Jan. 10, 2020.

(51) Int. Cl. B01D 67/00; B01D 61/02; B01D 61/08; B01D 69/08; B01D 69/02; C02F 1/44

(52) U.S. Cl. CPC B01D 67/0088; B01D 61/02; B01D 61/08; B01D 69/08; B01D 69/02; C02F 1/442; C02F 2101/306

(57) ABSTRACT

An apparatus and method for filtering a fluid is provided. The apparatus includes a filtration unit having an inlet and hollow fiber membranes. The hollow fiber membranes are each formed from an elongated tube having an exterior surface and an interior surface. The hollow fiber membranes are configured to separate the filtration unit into a permeate side that allows permeate to exit the filtration unit through a permeate outlet and a retentate side that allows retentate to exit the filtration unit through a retentate outlet. The hollow fiber membranes include a coating linked to the exterior surface or interior surface of the hollow fiber membranes. The coating includes a poly electrolyte electrostatically coupled to the charged exterior surface or the charged interior surface.

### BACKGROUND

Water softening is the removal of metal cations (e.g., magnesium and calcium) that contribute to water hardness. Water softening extends the life of plumbing by reducing or eliminating scale build-up in pipes and fittings. The resulting soft water requires less soap for the same cleaning effect, as soap is not wasted through bonding calcium and magnesium ions. Water softening for residential point-of-use or point-of-entry is typically achieved using ion-exchange resins or reverse osmosis systems.

Ion-exchange systems typically utilize microbeads having a charged resin that will take hardness salts out of the water and replace it with sodium (which does not add to the hardness). Once the resin is full with hardness salts, it needs to be regenerated. Regenerating the ion-exchange resins typically includes soaking the resin in a concentrated salt solution. The concentrated hardness salt solution is discharged to a drain.

Ion-exchange systems are widely used in industrial and residential water treatment systems. Ion-exchange systems are environmentally friendly, can provide a high flow rate of treated water, and have relatively low maintenance costs. However, ion-exchange systems suffer from disadvantages such as calcium sulfate fouling, iron fouling, adsorption of organic matter, and organic contamination leaching into treated water from the resin. Further, ion-exchange systems are susceptible to bacterial contamination, chlorine contamination, and do not remove chemicals of concern, such as pesticides, pharmaceuticals, and poly fluorinated alkyl substances (PFAS), among others. Finally, ion-exchange systems need to be regenerated when the resins are exhausted, which requires treating the ion-exchange resin beads with a high concentration brine solution.

Reverse osmosis includes filtering liquid by passing the liquid through a semi-permeable membrane having pores large enough for solvent to pass, but small enough to retain the passage of solute contaminant. By pressurizing the liquid above its osmotic pressure, the solvent liquid molecules will diffuse across the membrane, but the solute molecules will remain. The resulting brine is then discarded and the filtered solvent is retained. Such reverse-osmosis systems can be configured to produce purified water from virtually any source.

While this is advantageous for many reasons and in many applications, it is nonetheless imperfect for the production of drinking water. Specifically, the reverse-osmosis process is not selective. That is, reverse osmosis removes all dissolved mineral ions, both of which are desirable for health and taste along with those which are not. Maintaining an appropriate amount of minerals in drinking water is considered beneficial for human health, e.g., standards set forth by World Health Organization (“Nutrients in Drinking Water”, 2005). The flavor of water may also be improved by maintaining levels of dissolved minerals and alkalinity, as well as the flavor of food and beverages created using water. Further, drinking water typically includes chlorine. However, chlorine must be removed before being passed through a reverse osmosis system, as chlorine is destructive to reverse osmosis membranes. As such, chlorine removal requires an additional step to remove chlorine in water downstream of the reverse osmosis system.

### SUMMARY

Some embodiments provide an apparatus and method for filtering a fluid. In some embodiments, the apparatus includes a filtration unit having an inlet and one or more hollow fiber membranes. The hollow fiber membranes are each formed from an elongated tub e having an exterior surface and an interior surface that defines a hollow chamber and allows the passage of fluid. The hollow fiber membranes are configured to separate the filtration unit into a permeate side that allows permeate to exit the filtration unit through a permeate outlet, and a retentate side that allows retentate to exit the filtration unit through a retentate outlet. The hollow fiber membranes include a coating associated with the exterior surface or interior surface of the hollow fiber membranes. The coating including one or more polyelectrolyte electrostatically coupled to the charged exterior surface or the charged interior surface.

In some embodiments, a hollow fiber membrane that is chlorine resistant is provided, thereby simplifying operations by removing the pre-treatment step required by reverse osmosis systems. In contrast to conventional reverse osmosis and nanofiltration systems, which remove almost all ions or all multivalent ions from the filtered fluid, some embodiments provide a hollow fiber membrane having a coating and/or film that may be configured to partially remove multivalent ions (e.g., divalent, trivalent, tetravalent), while additionally allowing monovalent ions (e.g., sodium, potassium) to pass through. Allowing the passage of some multivalent ions offers benefits over traditional reverse osmosis and nanofiltration systems. For example, the hollow fiber membrane according to some embodiments of the invention may reduce the total dissolved solids (TDS) or hardness of the water to sufficiently mitigate scaling (e.g., hardness 180 ppm or less) or substantially eliminate scaling (e.g., hardness of 20 ppm or less), while retaining minerals beneficial for a subject's heath and taste of the permeate stream (e.g., magnesium and calcium). In some embodiments, the coating and/or film's thickness and composition, among other things, may influence the hollow fiber membrane to selectively permeate multivalent ions in an amount sufficient to mitigate or eliminate scaling, while retaining a sufficient amount to maintain taste and health benefits.

Some embodiments of the invention provide a hollow fiber membrane that removes bacteria, viruses, and chemicals of concern (e.g., pesticides, pharmaceuticals, poly-fluorinated-alkyl substances (PFAS), among others), that are not removed by ion-exchange systems. In some embodiments, the hollow fiber membrane removes all or substantially all of the bacteria, viruses, and chemicals of concern from the inlet fluid. In some embodiments, the permeate stream discharging from the hollow fiber membrane is entirely free of or substantially free of bacteria, viruses, and chemicals of concern. In some embodiments, the term “substantially free of” may refer to less than 1%, less than 0.5%, less than 0.1%, or less than 0.01%, or less than 0.001% (w/w) of the compound or chemical entity. In some embodiments, the permeate stream discharging from the filtration unit has a bacteria and virus rejection of greater than or equal to 99%, or greater than or equal to 99.9%. In some embodiments, the permeate stream has a rejection for pesticides, pharmaceuticals, and poly-fluorinated-alkyl substances (PFAS) of greater than or equal to 80%, or greater than or equal to 85%, or greater than or equal to 90%.

In some embodiments, a hollow fiber membrane that partially removes multivalent salts (e.g., divalent ions such as magnesium and calcium) without the need to be regenerated in a concentrated salt solution is provided.

The foregoing and other aspects and advantages of the disclosure will appear from the following description. In the description, reference is made to the accompanying drawings that form a part hereof, and in which there is shown by way of illustration a non-limiting example embodiment. This embodiment does not necessarily represent the full scope of the invention, however, and reference is therefore made to the entire disclosure herein for interpreting the scope of the invention.

### BRIEF DESCRIPTION OF THE DRAWINGS

The invention will hereafter be described with reference to the accompanying drawings, wherein like reference numerals denote like elements.

FIG. 1 is a schematic illustration of an apparatus for filtering an inlet fluid in accordance with an embodiment;

FIG. 2 is a schematic illustration of an apparatus for filtering an inlet fluid in accordance with an embodiment;

FIGS. 3A-3C are schematic illustrations of a coating applied to an exterior or an interior surface of a hollow fiber membrane in accordance with an embodiment; and

FIG. 4 is a flowchart illustrating a method of filtering a fluid using the apparatus of FIG. 1 in accordance with an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

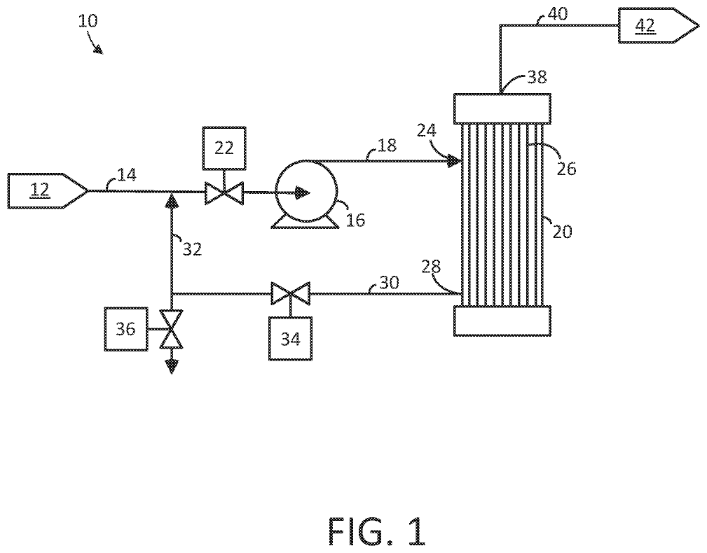

FIG. 1 illustrates an apparatus 10 for filtering an inlet fluid 12. The apparatus 10 includes an inlet line 14 that places the inlet fluid 12 in fluid communication with a pump 16. The pump 16 includes a suction side for receiving the inlet fluid 12, and a discharge side that dispenses pressurized fluid into a feed line 18. The feed line 18 places the pump 16 in fluid communication with a filtration unit 20. The pump 16 and inlet valve 22 may be used to regulate the flow rate of pressurized fluid to the filtration unit 20. The desired flow rate to the filtration unit 20 may be determined based on signals from one or more sensors (e.g., pressure sensor, temperature sensor, flow rate sensor, analyte concentration) and a controller. In some embodiments, the inlet fluid 12 includes a fluid having solute and contaminants in need of filtering. Exemplary solutes and contaminants include, but are not limited to, metal ions, aqueous salts, sediment, chemicals of concern, bacteria, viruses, pharmaceuticals, etc.

The filtration unit 20 includes a filtration inlet 24 configured to receive the pressurized fluid in the feed line 18, and place the filtration unit 20 in fluid communication with the pump 16. The filtration unit 20 includes filtration media 26 positioned within the filtration unit 20 that is configured to separate the pressurized fluid into a retentate stream having fluid, solute, and contaminants that are rejected or retained by the filter media 26, and a permeate stream having filtered fluid that permeates or diffuses through the filter media 26.

The filtration unit 20 includes a retentate outlet 28 that discharges the retentate stream into a retentate line 30. A recycle line 32 may place the retentate line 30 in fluid communication with the inlet line 14, or a drain to discard or further process the retentate stream. A retentate valve 34 may be configured in the retentate line 30, and a recycle valve 36 may b e configured in the recycle line to regulate the flow rate of recycled fluid in the retentate stream. The filtration unit 20 includes a permeate outlet 38 that discharges the permeate stream into a permeate line 40. The permeate line 40 may be fed to a downstream process unit 42.

The apparatus 10 may be used as a point-of-use filter system where the downstream process unit 42 includes, but is not limited to, a faucet configured to dispense drinking water or filtered fluid (e.g., kitchen sink, refrigerator, bathroom sink, and industrial or commercial process unit in need of filtered fluid). Additionally or alternatively, the apparatus 10 may be used as a point-of-entry filter system where the downstream process unit 42 includes, but is not limited to, a user's home or industrial process facility.

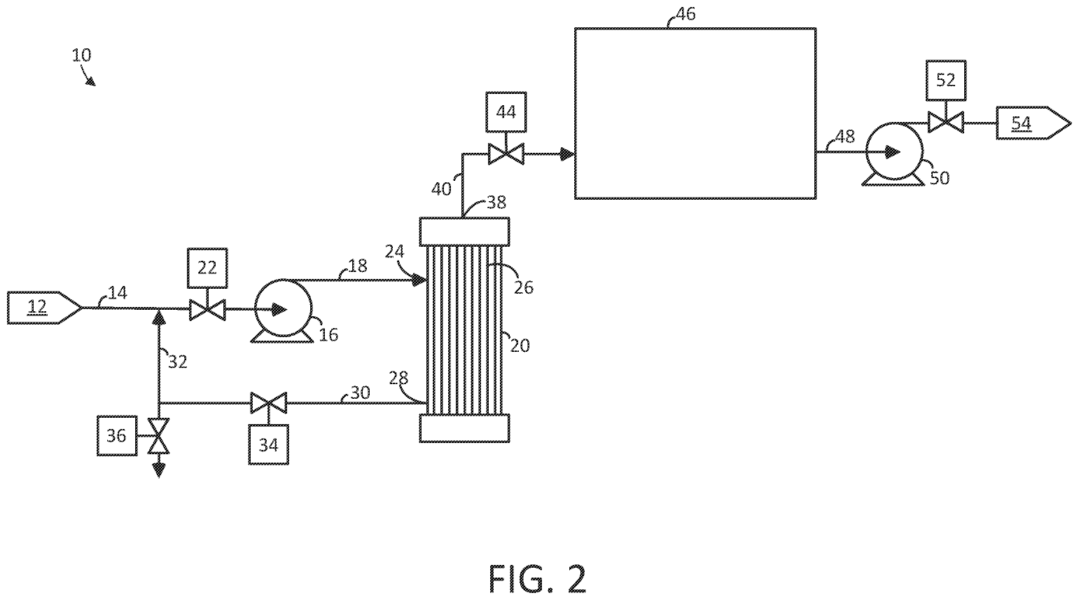

Referring to FIG. 2, the permeate line 40 may place the filtration unit 20 in fluid communication with a holding tank 46. The holding tank 46 may act as a reservoir to store permeate fluid to handle surge capacity needs for downstream processing unit 54, such as a point-of-use or point-of-entry system. The holding tank 46 may be placed in fluid communication with the downstream processing unit 54 via a conduit 48. A valve 44 may be configured in the permeate line 40 to control the flow of permeate fluid from the filtration unit 20 to the holding tank 46. A pump 50 and a valve 52 may be configured in the conduit 48 to regulate the flow rate of permeate fluid from the holding tank 46 to the downstream processing unit 50.

In some embodiments, the filtration media 26 includes one or more semi-permeable membrane materials. As used herein, the term “membrane” may refer to a selective barrier that allows specific entities (such as molecules and/or ions) to pass through, while retaining the passage of others. The ability of a membrane to differentiate among entities (based on, for example, their size and/or charge and/or other characteristics) may be referred to as “selectivity.” In some embodiments, the membranes described herein may be formed from synthetic or polymeric materials having pores suited for ultrafiltration or nanofiltration.

The filtration unit 20 may be sized for a point-of-use system. In some embodiments, the filtration unit 20 includes a housing diameter that ranges from 50 mm to 150 mm. In some embodiments, the filtration unit has a housing diameter of at least 50 mm, or at least 60 mm, or at least 70 mm, or at least 80 mm, or at least 90 mm, or at least 100 mm, or more. In some embodiments, the filtration unit 20 includes a housing diameter that is at most 110 mm, or at most 120 mm, or at most 130 mm, or at most 140 mm, or at most 150 mm, or more. In some embodiments, the filtration unit 20 includes a housing diameter from at least 50 mm, or at least 60 mm, or at least 70 mm, or at least 80mm, or at least 90 mm, or at least 100 to at most 110 mm, or at most 120 mm, or at most 130 mm, or at most 140 mm, or at most 150 mm. In some embodiments, the filtration unit 20 includes a module length that ranges from 500 mm to 1000 mm. In some embodiments, the filtration unit 20 has a module length of at least 500 mm, or at least 550 mm, or at least 600 mm, or at least 650 mm, or at least 700 mm, or at least 750 mm, or more. In some embodiments, the filtration unit 20 has a module length of at most 800 mm, or at most 850 mm, or at most 900 mm, or at most 950 mm, or at most 1000 mm, or more. In some embodiments, the filtration unit 20 has a module length from at least 500 mm, or at least 550 mm, or at least 600 mm, or at least 650 mm, or at least 700 mm, or at least 750 mm to at most 800 mm, or at most 850 mm, or at most 900 mm, or at most 950 mm, or at most 1000 mm. In some embodiments, the filtration unit 20 includes a module area that ranges from 1 square meter (sqm) to 20 sqm. In some embodiments, the filtration unit 20 includes a module area of at least 1 sqm, or at least 2.5 sqm, or at least 5 sqm, or at least 7.5 sqm, or at least 10 sqm, or more. In some embodiments, the filtration unit includes a module area that is at most 12.5 sqm, or at most 15 sqm, or at most 17.5 sqm, or at most 20 sqm, or more. In some embodiments, the filtration unit 20 includes a module area from at least 1 sqm, or at least 2.5 sqm, or at least 5 sqm, or at least 7.5 sqm, or at least 10 sqm to at most 12.5 sqm, or at most 15 sqm, or at most 17.5 sqm, or at most 20 sqm.

The filtration unit 20 may be sized for a point-of-entry system. In some embodiments, the filtration unit 20 includes a housing diameter that ranges from 2 inches to 6 inches. In some embodiments, the filtration unit 20 includes a housing diameter that is at least 2 inches, or at least 3 inches, or at least 4 inches, or more. In some embodiments, the filtration unit 20 includes a housing diameter that is at most 4 inches, or at most 5 inches, or at most 6 inches, or more. In some embodiments, the filtration unit 20 includes a housing diameter from at least 2 inches, or at least 3 inches, or at least 4 inches to at most 5 inches, or at most 6 inches. In some embodiments, the filtration unit 20 includes a module length that ranges from 20 inches to 40 inches. In some embodiments, the filtration unit 20 includes a module length that is at least 20 inches, or at least 22.5 inches, or at least 25 inches, or at least 27.5 inches, or at least 30 inches, or more. In some embodiments, the filtration unit 20 includes a module length that is at most 32.5 inches, or at most 35 inches, or at most 37.5 inches, or at most 40 inches, or more. In some embodiments, the filtration unit 20 includes a module length from at least 20 inches, or at least 22.5 inches, or at least 25 inches, or at least 27.5 inches, or at least 30 inches to at most 32.5 inches, or at most 35 inches, or at most 37.5 inches, or at most 40 inches. In some embodiments, the filtration unit 20 has a module area that ranges between 10 square feet (sqft) to 200 s q ft. In some embodiments, the filtration unit 20 has a module area that is at least 10 sqft, or at least 20 sqft, or at least 30 sqft, or at least 40 sqft, or at least 50 sqft, or at least 60 sqft, or at least 70 sqft, or at least 80 sqft, or at least 90 sqft, or at least 100 sqft, or more. In some embodiments, the filtration unit 20 has a module area that is at most 110 sqft, or at most 120 sqft, or at most 130 sqft, or at most 140 sqft, or at most 150 sqft, or at most 160 sqft, or at most 170 sqft, or at most 180 sqft, or at most 190 sqft, or at most 200 sqft, or more. In some embodiments, the filtration unit 20 has a module area from at least 10 sqft, or at least 20 sqft, or at least 30 sqft, or at least 40 sqft, or at least 50 sqft, or at least 60 sqft, or at least 70 sqft, or at least 80 sqft, or at least 90 sqft, or at least 100 sqft to at most 110 sqft, or at most 120 sqft, or at most 130 sqft, or at most 140 sqft, or at most 150 sqft, or at most 160 sqft, or at most 170 sqft, or at most 180 sqft, or at most 190 sqft, or at most 200 sqft.

As used herein, the term “ultrafiltration” or “UF” may refer to a membrane separation technique used to separate small particles and dissolved molecules in fluids. The primary basis for separation may be molecular size, although other factors, such as but not limited to, molecule shape and charge, can also be a basis for separation. Molecules larger than the membrane pores will generally be retained at the surface of the membrane and concentrated during the ultrafiltration process. The retention properties of ultrafiltration membranes may b e expressed as “Molecular Weight Cutoff” (MWCO). This value may refer to the approximate molecular weight (MW) of a molecule, compound and/or material (such as polymers, proteins, colloids, polysaccharides, suspended solids and/or solutes), which is about 90% or more retained by the membrane. However, a molecule's shape can have a direct effect on its retention by a membrane. For example, linear molecules like DNA may find their way through pores that will retain a globular species of the same molecular weight.

Ultrafiltration membranes may be adapted to let small molecules (such as water, low-molecular-weight organic solutes, and salts) pass, but retain high-molecular weight molecules (such as, polymers, proteins, colloids, polysaccharides, and/or suspended solids and solutes of molecular weight greater than 1,000). Ultrafiltration (UF) may also relate to a technique that utilizes membranes having pores of about 5 to 100 nanometer (nm) in diameter.

As used herein, the term “nanofiltration” or “NF” may be related to a technique that utilizes membranes that retain some low and medium molecular weight solutes, while not retaining others. NF membranes may be adapted to let through monovalent ions and organic compounds with low molecular weight (typically less than about 300 g/mol) and retain all multivalent ions (for example, calcium, magnesium, aluminum, sulfates ions and others), non -ionized organic compounds (for example solutes) with high molecular weight (typically higher than about 300 g/mol) and suspended solids. Typically, NF membranes' selectivity is characterized by separations of monovalent and divalent salts and organic solutes of molecular weights up to 1000. In some embodiments, the nanofiltration membranes may have pores that range between about 1 and 10 nm in diameter.

In an embodiment, the membrane has a pore size greater than or equal to 1 nm, or from greater than or equal to 1 nm to less than or equal to 100 nm. In a further embodiment, the membrane has a pore size from greater than or equal to 1 nm, or 5 nm, or 10 nm, or 20 nm, or 30 nm, or 40 nm to 50 nm, or 60 nm, or 70 nm, or 80 nm, or 90 nm, or 100 nm. In another embodiment, the membrane has a pore size from greater than or equal to 1 nm to less than or equal to 10 nm. In a further embodiment, the membrane has a pore size from greater than or equal to 1 nm to 2 nm, or 3 nm, or 4 nm, or 5 nm, or 6 nm, or 7 nm, or 8 nm, or 9 nm, or 10 nm.

Some embodiments provide a filtration technology that straddles a boundary between nanofiltration and ultrafiltration. For example, some embodiments provide a filtration technique that allows the passage of a sufficient amount of multivalent ions to retain benefits associated with having these ions in the permeate stream, such as taste and health benefits (e.g., retaining a portion of magnesium and calcium from the inlet fluid), while advantageously removing a sufficient amount of multivalent ions to avoid disadvantages associated with having multivalent ions in the permeate stream, such as scaling due to water hardness and/or reducing detergent and soap performance. This is in contrast to conventional nanofiltration, which typically removes all multivalent ions, and ultrafiltration, which typically allows the passage of all multivalent ions.

In some embodiments, the filtration media 26 includes hollow fiber membranes. The hollow fibers membranes each may be provided in the form of an elongate tube having an exterior surface and an interior surface that encloses a hollow channel. The hollow fiber membranes may be arranged in the filtration unit 20 in an “inside-outside” or “outside-inside” arrangement. For example, in the “inside-outside” arrangement, pressurized fluid from the feed line 18 enters the hollow channel of the hollow fiber membranes. A portion of the fluid permeates through the hollow fiber membrane from the interior surface to the exterior surface, where it exits the filtration unit 20 through the permeate outlet 38. In the “outside-inside” arrangement, pressurized fluid from the feed line 18 contacts the exterior surface of the hollow fiber membranes, where a portion of the fluid permeates through the hollow fiber membrane from the exterior surface to the interior surface. In this arrangement, the hollow channel within the interior surface of the hollow fiber membrane is in fluid communication with the permeate outlet 38.

In some embodiments, the hollow fiber membranes have an inner diameter that ranges from 0.5 mm to 3 mm. In some embodiments, the hollow fiber membranes have an inner diameter that is at least 0.5 mm, or at least 0.6 mm, or at least 0.7 mm, or at least 0.8 mm, or at least 0.9 mm, or at least 1 mm, or at least 1.1 mm, or at least 1.2 mm, or at least 1.3 mm, or at least 1.5 mm, or more. In some embodiments, the hollow fiber membranes have an inner diameter that is at most 1.5 mm, or at most 1.6 mm, or at most 1.7 mm, or at most 1.8 mm, or at most 1.9 mm, or at most 2 mm, or at most 2.1 mm, or at most 2.2 mm, or at most 2.3 mm, or at most 2.4 mm, or at most 2.5 mm, or at most 2.6 mm, or at most 2.7 mm, or at most 2.8 mm, or at most 2.9 mm, or at most 3 mm, or more. In some embodiments, the hollow fiber membranes have an inner diameter from at least 0.5 mm, or at least 0.6 mm, or at least 0.7 mm, or at least 0.8 mm, or at least 0.9 mm, or at least 1 mm, or at least 1.1 mm, or at least 1.2 mm, or at least 1.3 mm, or at least 1.5 mm to at most 1.6 mm, or at most 1.7 mm, or at most 1.8 mm, or at most 1.9 mm, or at most 2 mm, or at most 2.1 mm, or at most 2.2 mm, or at most 2.3 mm, or at most 2.4 mm, or at most 2.5 mm, or at most 2.6 mm, or at most 2.7 mm, or at most 2.8 mm, or at most 2.9 mm, or at most 3 mm.

In some embodiments, the hollow fiber membranes may include pore sizes suited for ultrafiltration. In some embodiments, the hollow fiber membrane may be formed from synthetic or polymeric materials including, but not limited to, cellulose acetate, a sulfonated polymer, a fluorinated polymer, polysulfone, polyphenylsulfone, polyphenylene sulfone, polyethersulfone, polyetherketone, polyether ketone ether ketone, polyvinylidene fluoride, polytetraethylene, polyhexafluoropropylene, polychlorotrifluoroethylene, derivatives and combinations thereof.

In some embodiments, the synthetic or polymeric materials include one or more backbone modifications. For example, the backbone of the polymer may include an ionic charge, such as an anionic modification or a cationic modification. In some embodiments, the backbone may be modified to include one or more ionic moiety including, but not limited to a sulfonic group, a phosphoric group, a carboxylic group, or an ammonium group. In some embodiments, the backbone modification may be made across the entire membrane. Alternatively, the interior surface and/or the exterior surface of the hollow fiber membranes may include the backbone modification to impart an ionic charge across at least a portion the respective surface.

In some embodiments, the hollow fiber membrane includes a coating and/or film linked to the internal surface and/or external surface of the hollow fiber membrane. As used herein, the term “linked” may refer to the coating and/or film being coupled to the surface of the hollow fiber membrane through a covalent bond, an electrostatic bond, or other intermolecular forces, such as van der Waals forces and London dispersion forces. The coating and/or film may be used to modify the UF or NF membrane to improve rejection and/or controllably alter the selectivity of the membrane for certain solutes or ions. The selectivity may be tuned by altering the coating and/or film's thickness and composition according to various embodiments described herein.

In some embodiments, the coating and/or film includes at least one polyelectrolyte linked to the internal surface and/or external surface of the hollow fiber membrane. As used herein, the term “polyelectrolyte” may refer to a polymer whose rep eating units or side chain modifications includes one or more electrolyte groups (e.g., polycations having positively charged electrolyte groups, polyanions having negatively charged electrolyte groups, and/or polyampholytes having both positively and negatively charged electrolyte groups). These electrolyte groups dissociate in an aqueous solutions, making the polymers charged. When placed in solution, the polyelectrolytes may be linked to the surface of the hollow fiber membrane using deposition techniques, such as layer-by-layer (LbL) deposition.

During layer-by-layer deposition, the hollow fiber membrane surface is dipped back and forth between baths containing positively charged and negatively charged polyelectrolyte solutions. In some embodiments, the hollow fiber membrane is washed between “dips.” During each dip, an amount of polyelectrolyte is adsorbed and the surface charge is reversed, allowing gradual and controlled build-up of ionically linked films of polycation-polyanion bi-layers. In some embodiments, the polycation electrolytes include polymers having quaternary ammonium groups, such as polyethylene quaternary ammonium moieties. Exemplary quaternary ammonium poly electrolytes include, but are not limited to, polydiallyldimethylammonium chloride (polyDADMAC). In some embodiments, the polyanion electrolytes include polymers having sulfonic groups, phosphoric groups, and/or carboxylic group, such as poly(sodium styrene sulfonate) and/or polyacrylic acid.

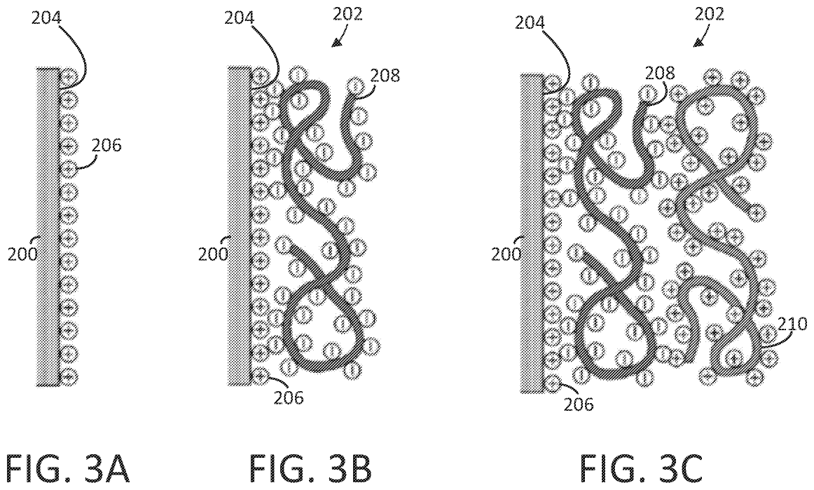

FIGS. 3A-3C provide a schematic illustration of the coating and/or film 202 provided on the internal surface and/or external surface 204 of the hollow fiber membrane 200. Referring to FIG. 3A, an internal surface and/or external surface 204 of the hollow fiber membrane 200 is illustrated with an ionic backbone modification 206, as shown by the (+) charge on the surface 204. The ionic backbone modification 206 may act as a base layer for linking the coating 202 to the membrane 200. FIG. 3B illustrates a coating 202 having a polyanion 208 (e.g., poly(styrene sulfonate)) ionically linked to the surface 204 of the hollow fiber membrane 200. FIG. 3C illustrates a coating 202 having a polycation 210 ionically linked with the polyanion 208 in the coating 202.

In contrast to conventional reverse osmosis and nanofiltration systems, which remove almost all ions or all multivalent ions from the filtered fluid, some embodiments described herein provide a hollow fiber membrane having a coating and/or film that may be configured to partially remove multivalent ions (e.g., divalent, trivalent, tetravalent), while additionally allowing monovalent ions (e.g., sodium, potassium) to pass through. Allowing the passage of some multivalent ions offers benefits over traditional reverse osmosis and nanofiltration systems. For example, the hollow fiber membrane according to some embodiments of the invention may reduce the total dissolved solids (TDS) or hardness of the water to sufficiently mitigate scaling (e.g., hardness 180 ppm or less) or substantially eliminate scaling (e.g., hardness of 20 ppm or less), while retaining minerals beneficial for a subject's heath and taste of the permeate stream (e.g., magnesium and calcium). In some embodiments, the coating and/or film's 202 thickness and composition, among other things, may influence the hollow fiber membrane 200 to selectively permeate multivalent ions in an amount sufficient to mitigate or eliminate scaling, while retaining a sufficient amount to maintain taste and health benefits.

In some embodiments, the coating and/or film 202 may be applied to the membrane 200 in an amount sufficient such that when a permeate stream passes through the membrane 200, the membrane 200 retains at least 30% of the multivalent ions relative to the inlet fluid 12. As used herein, the term “retain” may be defined as

$$1 - \frac{{C}_{p}}{{C}_{f}} ,$$

where Cₚ is the concentration of a specified ion(s) in the permeate (e.g., total number of calcium ions, total multivalent ions), and C_{f} is the concentration of a specified ion(s) in the inlet fluid 12.

In some embodiments, the coating and/or film 202 may be applied to the membrane in an amount sufficient such that that when a permeate stream passes through the membrane 200, the membrane 200 retains at least 30% of the multivalent ions of the inlet fluid 12 and/or the feed line 18, or at least 31%, or at least 32%, or at least 34%, or at least 35%, or at least 36%, or at least 37%, or at least 38%, or at least 39%, or at least 40%, or at least 41%, or at least 42%, or at least 43%, or at least 44%, or least 45%, or at least 46%, or at least 47%, or at least 48%, or at least 49%, or at least 50%, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or least 75%, or at least 76%, or at least 77%, or at least 78%, or at least 79%, or at least 80%, or more. In some embodiments, the membrane 200 retains from at least 30% of the multivalent ions of the inlet fluid 12 and/or the feed line 18, or at least 31%, or at least 32%, or at least 34%, or at least 35%, or at least 36%, or at least 37%, or at least 38%, or at least 39%, or at least 40%, or at least 41%, or at least 42%, or at least 43%, or at least 44%, or least 45%, or at least 46%, or at least 47%, or at least 48%, or at least 49%, or at least 50%, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or least 75%, or at least 76%, or at least 77%, or at least 78%, or at least 79%, or at least 80% to 81%, or 82%, or 83%, or 84%, or 85%, or 86%, or 87%, or 88%, or 89%, or 90%, or 91%, or 92%, or 93%, or 94%, or 95%, or 96%, or 97%, or 98%, or 99%, or less than 100%.

In some embodiments, the coating and/or film 202 may be applied to the membrane in an amount sufficient such that when a permeate stream passes through the membrane 200, the membrane 200 retains at least 35% of the calcium ions of the inlet fluid 12, or at least 36%, or at least 37%, or at least 38%, or at least 39%, or at least 40%, or at least 41%, or at least 42%, or at least 43%, or at least 44%, or least 45%, or at least 46%, or at least 47%, or at least 48%, or at least 49%, or at least 50%, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or more. In some embodiments, the coating and/or film 202 may be applied to the membrane in an amount sufficient such that when a permeate stream passes through the membrane 200, the membrane 200 retains from at least 35% of the calcium ions of the inlet fluid 12, or at least 36%, or at least 37%, or at least 38%, or at least 39%, or at least 40%, or at least 41%, or at least 42%, or at least 43%, or at least 44%, or least 45%, or at least 46%, or at least 47%, or at least 48%, or at least 49%, or at least 50%, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70% to 71%, or 72%, or 73%, or 74%, or 75%, or 78%, or 79%, or 80%, or 82%, or 84%, or 86%, or 88%, or 90%, or 92%, or 94%, or 96%, or 98%, or less than 100%.

In some embodiments, the coating and/or film 202 may be applied to the membrane in an amount sufficient such that when a permeate stream passes through the membrane 200, the membrane 200 retains at least 50% of the magnesium ions of the inlet fluid 12, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79%, or at least 80%, or at least 81%, or at least 82%, or at least 83%, or at least 84%, or at least 85%, or at least 86%, or at least 87%, or at least 88%, or at least 89%, or at least 90%, or at least 91%, or at least 92%, or at least 93%, or at least 94%, or at least 95%, or more. In some embodiments, the coating and/or film 202 may be applied to the membrane in an amount sufficient such that when a permeate stream passes through the membrane 200, the membrane 200 retains from at least 50% of the magnesium ions of the inlet fluid 12, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79%, or at least 80%, or at least 81%, or at least 82%, or at least 83%, or at least 84%, or at least 85%, or at least 86%, or at least 87%, or at least 88%, or at least 89%, or at least 90%, or at least 91%, or at least 92%, or at least 93%, or at least 94%, or at least 95% to 96%, or 97%, or 98%, or 99%, or less than 100%.

In some embodiments, the coating and/or film 202 may be applied to the membrane in an amount sufficient such that when a permeate stream passes through the membrane 200, the membrane 200 retains at least 55% of the sulfate ions of the inlet fluid 12, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79%, or at least 80%, or more. In some embodiments, the coating and/or film 202 may be applied to the membrane in an amount sufficient such that when a permeate stream passes through the membrane 200, the membrane 200 retains from at least 55% of the sulfate ions of the inlet fluid 12, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79%, or at least 80% to 81%, or 82%, or 83%, or 84%, or 85%, or 86%, or 87%, or 88%, or 89%, or 90%, or 92%, or 94%, or 96%, or 98%, or less than 100%.

In some embodiments, the coating and/or film 202 may be applied to the membrane in an amount sufficient such that when a permeate stream passes through the membrane 200, the membrane 200 retains at least 85% of the phosphate ions of the inlet fluid 12, or at least 86%, or at least 87%, or at least 88%, or at least 89%, or at least 90%, or at least 91%, or at least 92%, or at least 93%, or at least 94%, or least 95%, or more. In some embodiment, the coating and/or film 202 may be applied to the membrane in an amount sufficient such that when a permeate stream passes through the membrane 200, the membrane 200 retains from at least 85% of the phosphate ions of the inlet fluid 12, or at least 86%, or at least 87%, or at least 88%, or at least 89%, or at least 90%, or at least 91%, or at least 92%, or at least 93%, or at least 94%, or least 95% to 96%, or 97%, or 98%, or 99%, or less than 100%.

In some embodiments, the retention measurements described herein may refer to the retention of a specified ion(s) while operating the apparatus 10 at a recovery between ab out 50% and 90%, or about 60% and 90%, or about 75% and 85%. As used herein, the term “recovery” or “recovery percentage” may be defined as:

$$Recovery \% = \frac{{Q}_{p}}{{Q}_{f}} ;$$

wherein Q_{f} is the flow rate of fluid to the filtration unit 20 and Qₚ is the flow rate of the permeate stream exiting the filtration unit 20.

In some embodiments, the coating and/or film 202 may include at least one bi-layer of polyanion 208 and polycation 210 linked to the surface 204. In some embodiments, the coating includes at least one bi-layer of polyanion 208 and polycation 210, or at least two bi-layers, or at least three bi-layers, or at least four bi-layers, or at least or five bi-layers, or at least six bi-layers, or at least seven bi-layers, or at least eight bi-layers, or at least nine bi-layers, or at least 10 bi-layers, or at least 15 bi-layers, or at least 20 bi-layers, or at least 30 bi-layers, or at least 40 bi-layers, or at least 50 bi-layers, or at least 60 bi-layers, or at least 70 bi-layers, or at least 80 bi-layers, or at least 90 bi-layers, or at least 100 bi-layers, or at least 200 bi-layers, or at least 300 bi-layers, or at least 400 bi-layers, or at least 500 bi-layers, or more.

In some embodiments, the coating and/or film has a thickness on the internal surface and/or external surface of the hollow fiber membrane of at least ab out 2 nm. In some embodiments, the coating and/or film has a thickness between 5 nm and 200 p.m, or a thickness of at least 2 nm, or at least 3 nm, or at least 4 nm, or at least 5 nm, or at least 6 nm, or at least 7 nm, or at least 8 nm, or at least 9 nm, or at least 10 nm, or at least 20 nm, or at least 30 nm, or at least 40 nm, or at least 50 nm, or at least 60 nm, or at least 70 nm, or at least 80 nm, or at least 90 nm, or at least 100 nm, or at least 150 nm, or at least 200 nm, or at least 300 nm, or at least 400 nm, or at least 500 nm, or at least 600 nm, or at least 700 nm, or at least 800 nm, or at least 900 nm, or at least 1 nm, or at least 10 nm, or at least 50 nm, or at least 100 nm, or at least 15 0 nm, or at least 200 nm, or more. In some embodiments, the coating and/or film has a thickness on the internal surface and/or external surface of the hollow fiber membrane from at least 2 nm, or at least 3 nm, or at least 4 nm, or at least 5 nm, or at least 6 nm, or at least 7 nm, or at least 8 nm, or at least 9 nm, or at least 10 nm, or at least 20 nm, or at least 30 nm, or at least 40 nm, or at least 50 nm, or at least 60 nm, or at least 70 nm, or at least 80 nm, or at least 90 nm, or at least 100 nm, or at least 150 nm, or at least 200 nm, or at least 300 nm, or at least 400 nm, or at least 500 nm, or at least 600 nm, or at least 700 nm, or at least 800 nm, or at least 900 nm, or at least 1 nm, or at least 10 nm, or at least 50 nm, or at least 100 nm, or at least 150 nm to 200 nm.

In some embodiments, the coating and/or film covers at least 1% of a cross-sectional area within the hollow channel of the hollow fiber membranes. In some embodiments, the coating and/or film covers between 0.1% and 30% of the cross-sectional area within the hollow channel, or at least 0.2% of the cross-sectional area, or at least 0.3%, or at least 0.4%, or at least 0.5%, or at least 0.6%, or at least 0.7%, or at least 0.8%, or at least 0.9%, or at least 1%, or at least 2%, or at least 3%, or at least 4%, or at least 5%, or more.

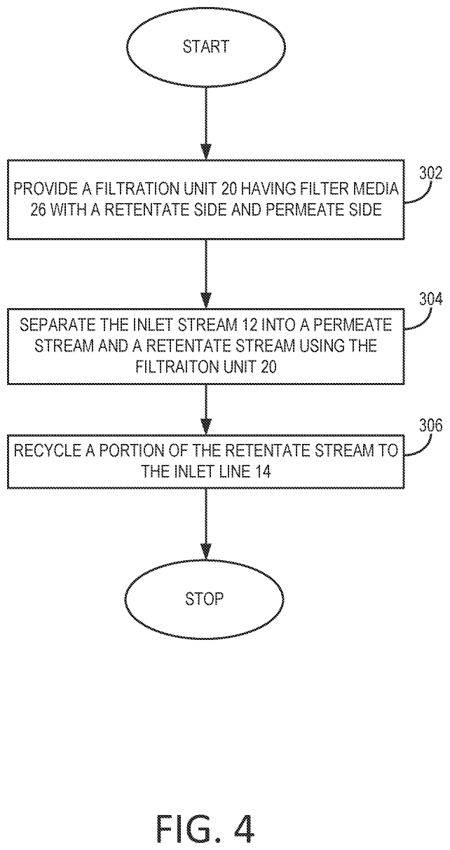

FIG. 4 illustrates a schematic flow diagram for operating the apparatus 10 to filter an inlet fluid 12. The method includes the initial step of providing at step 302 the filter media 26 having a retentate side and a permeate side within the filtration unit 20. An inlet fluid 12 is directed to the filtration unit 20 under pressure via pump 16. In some embodiments, the pump 16 pressurizes the fluid in the feed line 18 to a pressure of about 2 bar to about 10 bar, or more. The pump 16 and the valve 22 may regulate the flow rate of inlet fluid 12 to the filtration unit 20, which may be controlled based on one or more process signals (e.g., flow rate, pressure, permeate TDS content or hardness value, retentate TDS content or hardness value, and/or temperate within apparatus 10) via a controller (not shown) or manually set. In some applications, the flow rate of the inlet fluid 12 and/or the feed line 18 to the filtration unit 20 may range between 1 gallon per minute (gpm) and 20 gpm, or between 1 gpm and 10 gpm. In some embodiments, the inlet fluid 12 includes solutes and contaminants to be filtered. For example, in some applications, the inlet fluid 12 may have a total dissolved solid (TDS) content or a total hardness value between 10 ppm and 1000 ppm, or between 50 ppm and 500 ppm, or between 100 and 400 ppm, or more. In some instances, such as in industrial filtration, the TDS or total hardness value may be 10,000 ppm or greater.

As indicated by process step 304, the filtration unit 20 separates the inlet fluid 12 into a permeate stream that exits the filtration unit 20 through the permeate line 40, and a retentate stream that exists the filtration unit 20 through retentate line 30. In some embodiments, a portion of the retentate stream is recycled back to the inlet line 14, as indicated by step 306. The recycled fraction may be controlled using valves 34, 36 that direct the retentate stream between either the inlet line 14 or a drain. In some embodiments, the flow rate in the recycle line 32 is about equal to the flow rate in the inlet line 12, or the flow rate of the recycle line is ab out two times greater than the flow rate in the inlet line 12, or is at least three times great, or four times greater, or five times greater, or six times greater, or seven times greater, or eight times greater.

In some embodiments, the apparatus 10 operates at a recovery of at least 50%. In some embodiments, the apparatus 10 operates at a recovery of at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79%, or at least 80%, or at least 81%, or at least 82%, or at least 83%, or at least 84%, or at least 85%, or at least 86%, or at least 87%, or at least 88%, or at least 89%, or at least 90%, or at least 91%, or at least 92%, or at least 93%, or at least 94%, or at least 95%, or more. In some embodiments, the apparatus 10 operates at a recovery from at least 50%, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79% to 80%, or 81%, or 82%, or 83%, or 84%, or 85%, or 86%, or 87%, or 88%, or 89%, or 90%, or 91%, or 92%, or 93%, or 94%, or 95%.

In some embodiments, the apparatus 10 may be operated such that the permeate stream in the permeate line 40 has a TDS content or hardness value of less than 5 ppm, or less than 6 ppm, or less than 7 ppm, or less than 8 ppm, or less than 9 ppm, or less than 10 ppm, or less than 15 ppm, or less than 20 ppm, or less than 30 ppm, or less than 40 ppm, or less than 50 ppm, or at 60 ppm, or less than 70 ppm, or less than 80 ppm, or less than 90 ppm, or less than 100 ppm, or less than 110 ppm, or less than 120 ppm, or less than 130 ppm, or less than 140 ppm, or less than 150 ppm, or less than 160 ppm, or less than 170 ppm, or less than 180 ppm, or less than 190 ppm, or less than 200 ppm, or less than 250 ppm, or less than 300 ppm.

One or more non-limiting example embodiments have been provided, and it should be appreciated that many equivalents, alternatives, variations, and modifications, aside from those expressly stated, are possible and within the scope of the invention.

1. An apparatus for filtering an inlet fluid, the apparatus comprising:
a filtration unit having an inlet and hollow fiber membranes, the hollow fiber membrane s each formed from an elongated tube having an exterior surface and an interior surface that defines a chamber that allows the passage of fluid, the hollow fiber membranes separating the filtration unit into a permeate side that allows permeate to exit the filtration unit through a permeate outlet and a retentate side that allows retentate to exit the filtration unit through a retentate outlet,
at least a portion of the exterior surface or the interior surface being charged; and
a coating linked to the exterior surface or interior surface of the hollow fiber membranes, the coating including a polyelectrolyte ionically coupled to a charged exterior surface or a charged interior surface.

2. The apparatus of claim 1, wherein the coating includes at least one bi-layer comprising a polycation and a polyanion, wherein the polycation and the polyanion are ionically linked.

3. The apparatus of claim 2, wherein the polycation includes a quaternary ammonium group.

4. The apparatus of claim 2, wherein the anion includes at least one electrolyte group selected from a sulfonic group, a phosphoric group, or a carboxylic group.

5. The apparatus of claim 1, wherein the hollow fiber membranes comprise a polymeric material having pores, wherein the pores have a pore size of at least 1 nanometer.

6. The apparatus of claim 5, wherein the pore size ranges from 1 nanometers to 10 nanometers.

7. The apparatus of claim 1, wherein the coating is applied to the membranes in an amount sufficient such that when a permeate stream passes through the hollow fiber membrane s at least 40 percent of multivalent ions are retained by the hollow fiber membranes.

8. The apparatus of claim 1, wherein the coating is applied to the membranes in an amount sufficient such that when a permeate stream passes through the hollow fiber membranes at least 50 percent of multivalent ions in the permeate stream are retained by the membrane, and
wherein the retention is measured while the apparatus is operating at a recovery between 50 percent and 90 percent.

9. The apparatus of claim 1, wherein the coating has a thickness of at least 2 nanometers.

10. The apparatus of claim 1, wherein the coating includes at least one bi-layer, wherein the bi-layer is defined as an association of a polycation and a polyanion within the coating.

11. A method of using an apparatus for filtering a fluid, the method comprising:
coating an exterior surface or interior surface of hollow fiber membranes, the coating including a polyelectrolyte electrostatically coupled to the exterior surface or the interior surface to form a charged exterior surface or charged interior surface;
placing the hollow fiber membranes in a filtration unit; and
feeding the fluid to the filtration unit and separating the fluid into a permeate stream and a retentate stream that discharge from the filtration unit.

12. The method of claim 11, wherein the apparatus operates at a recovery of at least about 50 percent.

13. The method of claim 12, wherein the apparatus operates at a recovery between about 50 percent and 90 percent.

14. The method of claim 12, wherein at least about 40 percent of multivalent ions present in the fluid are retained by the hollow fiber membranes.

15. The method of claim 12, wherein at least about 35 percent of calcium ions present in the fluid are retained by the hollow fiber membranes.

16. The method of claim 12, wherein at least about 50 percent of the magnesium ions present in the fluid are retained by the hollow fiber membranes.

17. The method of claim 11, wherein at least a portion of the retentate stream is recycled back to an inlet of the filtration unit.

18. The method of claim 11, wherein the permeate stream has one or more of the following properties:
(i) a rejection for bacteria and viruses of greater than or equal to 99.9%; and
(ii) a rejection for pesticides, pharmaceuticals, and poly-fluorinated-alkyl substances (PFAS) of greater than or equal to 90%.
